(19) United States
(12) Patent Application Publication
(10) Pub. No.: US 2024/0200602 A1
(43) Pub. Date: Jun. 20, 2024

(54) Rolling Bearing

(71) Applicant: NIPPON THOMPSON CO., LTD., Tokyo (JP)

(72) Inventor: Kenichiro TSURUTA, Mino-shi, Gifu (JP)

(21) Appl. No.: 17/904,238

(22) PCT Filed: Sep. 17, 2021
(86) PCT No.: PCT/JP2021/034371

§ 371 Date: Jan. 29, 2024

(30) Foreign Application Priority Data
Sep. 25, 2020 (JP) 2020-161340

(51) Int. Cl. F16C 33/60; F16C 19/36; F16C 33/62

(52) U.S. Cl. CPC F16C 33/60; F16C 19/36; F16C 33/62

(57) ABSTRACT

A rolling bearing includes a steel outer ring, a steel inner ring having a common central axis with the outer ring and disposed on an inner circumference side of the outer ring, and a plurality of rolling elements disposed to be able to roll on an inner circumferential surface of the outer ring and an outer circumferential surface of the inner ring. The outer ring includes a first outer ring and a second outer ring that is arranged alongside the first outer ring in a first axis direction in which the central axis extends and is fixed to the first outer ring. The inner ring includes a first inner ring and a second inner ring that is arranged alongside the first inner ring in the first axis direction and is fixed to the first inner ring. One and the other of opposing portions in the first and second outer rings and in the first and second inner rings have a protruding portion and a through hole corresponding to the protruding portion formed respectively therein. The protruding portion and the through hole are fitted together, and the protruding portion and the through hole are bonded to each other.

### TECHNICAL FIELD

The present invention relates to a rolling bearing. The present application claims priority based on Japanese Patent Application No. 2020-161340 filed on Sep. 25, 2020, the entire contents of which are incorporated herein by reference.

### BACKGROUND ART

A rolling bearing having an outer ring and an inner ring each composed of a pair of plate members is known (see, e.g., Patent Literature 1).

### CITATION LIST

### Patent Literature

Patent Literature 1: Japanese Patent Application Laid-Open No. 2019-178735

### SUMMARY OF INVENTION

### Technical Problem

There is a need for a thin and easy-to-handle rolling bearing. Therefore, one of the objects is to provide a rolling bearing that is thin and easy to handle.

### Solution to Problem

A rolling bearing according to the present disclosure includes: an outer ring made of steel; an inner ring made of steel, having a common central axis with the outer ring and arranged on an inner circumference side of the outer ring; and a plurality of rolling elements disposed to be able to roll on an inner circumferential surface of the outer ring and an outer circumferential surface of the inner ring. The outer ring includes a first outer ring and a second outer ring arranged alongside the first outer ring in a first axis direction in which the central axis extends, the second outer ring being fixed to the first outer ring. The inner ring includes a first inner ring and a second inner ring arranged alongside the first inner ring in the first axis direction, the second inner ring being fixed to the first inner ring. One and the other of opposing portions in the first and second outer rings and in the first and second inner rings have a protruding portion and a through hole corresponding to the protruding portion formed respectively therein. The protruding portion and the through hole are fitted together, and the protruding portion and the through hole are bonded to each other.

### Advantageous Effects of Invention

According to the rolling bearing described above, a thin and easy-to-handle rolling bearing is provided.

### BRIEF DESCRIPTION OF DRAWINGS

FIG. 1 is a schematic perspective view showing the structure of a rolling bearing in Embodiment 1;

FIG. 2A is a schematic perspective view showing the structure of an outer ring of the rolling bearing in Embodiment 1;

FIG. 2B is a schematic perspective view showing the structure of the outer ring of the rolling bearing in Embodiment 1;

FIG. 3A is a schematic perspective view showing the structure of an inner ring of the rolling bearing in Embodiment 1;

FIG. 3B is a schematic perspective view showing the structure of the inner ring of the rolling bearing in Embodiment 1;

FIG. 4 is a schematic perspective view of Embodiment 1 with a first outer ring and a first inner ring removed therefrom;

FIG. 5 is a schematic cross-sectional view showing the structure of the rolling bearing in Embodiment 1;

FIG. 6 is a schematic cross-sectional view showing the structure of the rolling bearing in Embodiment 1;

FIG. 7 is a schematic diagram showing the states of grain flows in the outer and inner rings;

FIG. 8 is a schematic cross-sectional view showing the structure of the rolling bearing in Embodiment 1;

FIG. 9 is a schematic cross-sectional view showing the structure of the rolling bearing in Embodiment 1;

FIG. 10 is a schematic diagram showing exemplary shapes of a recess formed around a through hole in Embodiment 1;

FIG. 11 is a schematic perspective view showing the structure of a rolling bearing in Embodiment 2;

FIG. 12 is a schematic perspective view of Embodiment 2 with a first outer ring and a first inner ring removed therefrom;

FIG. 13 is an enlarged schematic perspective view of a portion of the schematic perspective view in FIG. 12, with a second inner ring removed and some of rolling elements omitted; and

FIG. 14 is a schematic plan view showing a variation in Embodiment 1.

### DESCRIPTION OF EMBODIMENTS

### Outline of Embodiments

First, embodiments of the present disclosure will be listed and described. A rolling bearing of the present disclosure includes: an outer ring made of steel; an inner ring made of steel, having a common central axis with the outer ring and arranged on an inner circumference side of the outer ring; and a plurality of rolling elements disposed to be able to roll on an inner circumferential surface of the outer ring and an outer circumferential surface of the inner ring. The outer ring includes a first outer ring and a second outer ring arranged alongside the first outer ring in a first axis direction in which the central axis extends, the second outer ring being fixed to the first outer ring. The inner ring includes a first inner ring and a second inner ring arranged alongside the first inner ring in the first axis direction, the second inner ring being fixed to the first inner ring. One and the other of opposing portions in the first and second outer rings and in the first and second inner rings have a protruding portion and a through hole corresponding to the protruding portion formed respectively therein. The protruding portion and the through hole are fitted together, and the protruding portion and the through hole are bonded to each other.

Conventionally, a rolling bearing as disclosed in Patent Literature 1, for example, is known. In the rolling bearing disclosed in Patent Literature 1, the outer ring and the inner ring constituting the rolling bearing are each made up of a pair of members divided in the axial direction (referred to as a pair of split rings of an outer ring and a pair of split rings of an inner ring). In the rolling bearing in Patent Literature 1, the pair of split rings of the outer ring and the pair of split rings of the inner ring are formed into predetermined shapes by press working or the like, and then a projection and a recess formed in one and the other of each pair of members are fitted together, whereby the split rings are fixed to each other.

Although a rolling bearing reduced in both thickness and weight is achieved by Patent Literature 1, there still is a need for a smaller and thinner rolling bearing. For example, it is conceivable to reduce the thickness of the steel plates to make the rolling bearing thinner and lighter. In such cases, the projection becomes shorter and the recess becomes shallower, leading to insufficient fixing force obtained by the fitting, so the split rings of the outer ring and/or the split rings of the inner ring may separate when subjected to strong vibrations during transportation or the like.

In the rolling bearing of the present disclosure, the outer ring is composed of the first outer ring and the second outer ring fixed to the first outer ring. Similarly, the inner ring is composed of the first inner ring and the second inner ring fixed to the first inner ring. In each pair of the first and second outer rings and the first and second inner rings, a protruding portion is formed in one of their opposing portions, and a through hole corresponding to the protruding portion is formed in the other of the opposing portions. The protruding portion and the through hole are fitted together, and the protruding portion and the through hole are bonded to each other. With this configuration, the first and second outer rings, as well as the first and second inner rings, can be fixed reliably. As a result, the durability of the fixation of the outer rings and of the inner rings can be improved. As such, according to the rolling bearing of the present disclosure, even in the case where the rolling bearing is thin in thickness, the outer rings and the inner rings are both reliably fixed, making the bearing easy to handle.

In the above rolling bearing, the first outer ring, the second outer ring, the first inner ring, and the second inner ring may each have both of the protruding portion and the through hole. With this configuration, the outer rings and the inner rings can be fixed more securely. Further, this configuration eliminates the distinction between the first and second outer rings and between the first and second inner rings, allowing the first and second outer rings to be members of the same shape and the first and second inner rings to be members of the same shape. According to this configuration, the number of types of components constituting the rolling bearing can be reduced, which is advantageous in terms of production process and quality control. Furthermore, the distinction between the front and back of the rolling bearing is eliminated, making the rolling bearing more convenient to use.

In the above rolling bearing, further, opposing surfaces of the first and second outer rings and opposing surfaces of the first and second inner rings may be bonded around a fitting portion made up of the protruding portion and the through hole fitted together. In the rolling bearing of the present disclosure, the protruding portion and the through hole forming the fitting portion are bonded to each other. That is, the wall surface constituting the protruding portion and the inner circumferential wall of the through hole are bonded to each other, and the bonded surface extends in the axial direction of the rolling bearing. In addition to this, the opposing surfaces of the outer rings and the opposing surfaces of the inner rings are bonded around the fitting portion, whereby the outer rings and the inner rings are bonded and fixed together also in the plane direction of the rolling bearing. By bonding the surfaces around the fitting portion in addition to the fitting portion, a single adhesive layer continuous over the axial and plane directions can be formed. According to such an adhesive layer, the outer rings and the inner rings can both be fixed more securely.

In the above rolling bearing, in the opposing surfaces of the first and second outer rings or in the opposing surfaces of the first and second inner rings, a portion around the through hole may be roughened, or a recess may be formed around the through hole. According to this configuration, the bonding area can be increased, making the fixation more secure. Further, according to this configuration, the adhesive can be prevented from spreading on the opposing surfaces and penetrating to the rolling surfaces of the rolling bearing.

In the above rolling bearing, the first outer ring has an annular first rolling surface constituting the inner circumferential surface of the outer ring. The second outer ring has an annular second rolling surface constituting the inner circumferential surface of the outer ring. The first inner ring has an annular third rolling surface constituting the outer circumferential surface of the inner ring and opposing the second rolling surface. The second inner ring has an annular fourth rolling surface constituting the outer circumferential surface of the inner ring and opposing the first rolling surface. In a cross section including a central axis of the first rolling surface, a line segment connecting the first rolling surface and the fourth rolling surface intersects a line segment connecting the second rolling surface and the third rolling surface. The first to fourth rolling surfaces may define an annular raceway through which the rolling elements are able to roll. At this time, opposing surfaces of the first and second outer rings and opposing surfaces of the first and second inner rings may each have a groove formed therein between the raceway and the fitting portion. This configuration can prevent the adhesive from entering into the raceway and from penetrating to the rolling surfaces.

In the above rolling bearing, the groove in the opposing surfaces of the first and second outer rings may have both ends opening toward an outer circumference of the outer ring. The groove in the opposing surfaces of the first and second inner rings may have both ends opening toward an inner circumference of the inner ring. According to this configuration, even in the case where an adhesive of an amount exceeding the volume of the groove enters, the adhesive is discharged to the outside of the bearing, thereby preventing the adhesive from entering the rolling surfaces.

In the above rolling bearing, in a cross section including the central axis of the rolling bearing, grain flows in the steel constituting the first outer ring may extend along the first rolling surface. Grain flows in the steel constituting the second outer ring may extend along the second rolling surface. Grain flows in the steel constituting the first inner ring may extend along the third rolling surface. Grain flows in the steel constituting the second inner ring may extend along the fourth rolling surface. This configuration can suppress contact of the rolling elements to the ends of the steel grain flows, and also improve the durability of the inner and outer rings. In addition to the above-described configuration ensuring fixation between the inner rings and between the outer rings, with the grain flows in the steels constituting the inner and outer rings being configured as described above, a thin, easy-to-handle, and highly durable rolling bearing can be obtained.

### Specific Embodiments

Specific embodiments of the rolling bearing of the present disclosure will be described below with reference to the drawings. In the drawings referenced below, the same or corresponding portions are denoted by the same reference numerals and the description thereof will not be repeated.

### Embodiment 1

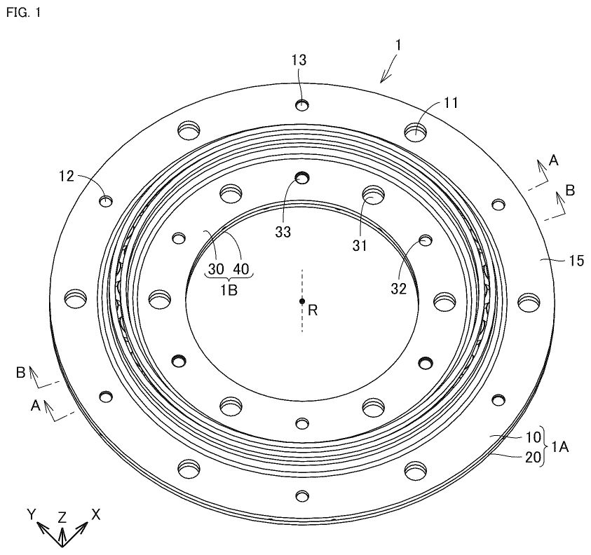

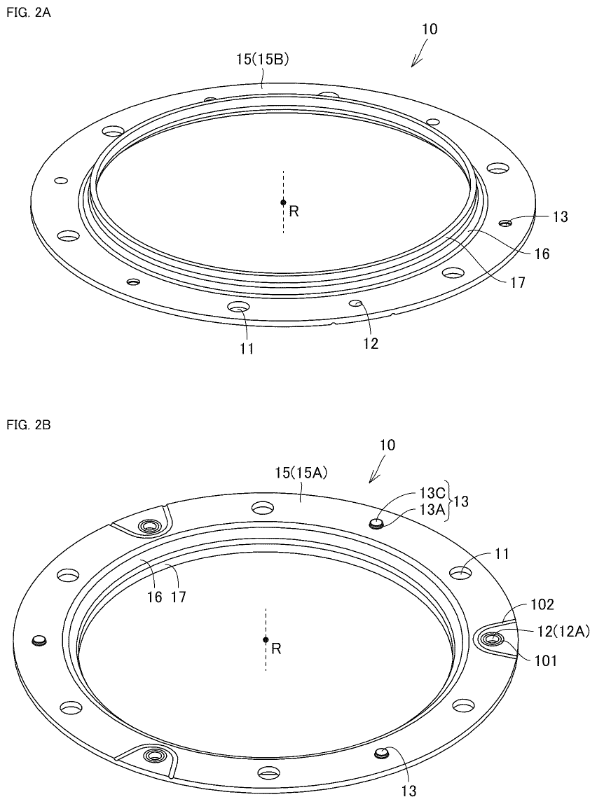

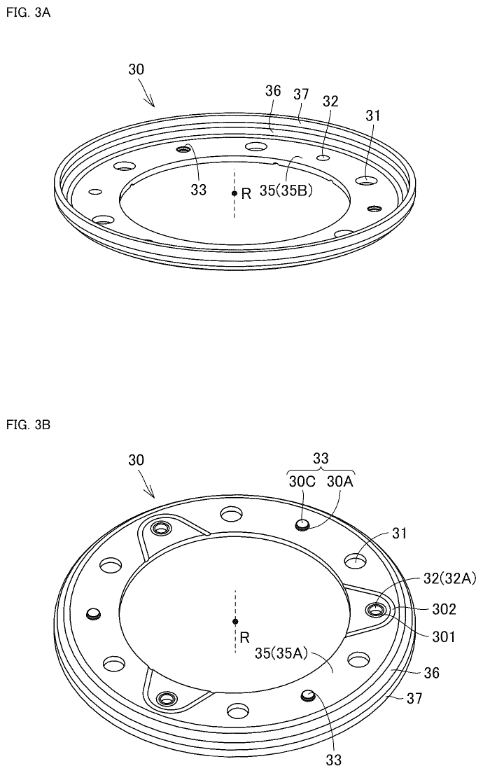

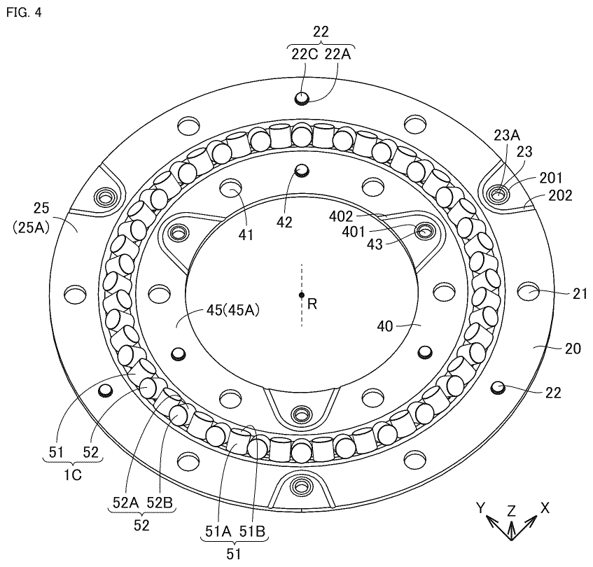

FIG. 1 is a schematic perspective view showing the structure of a rolling bearing in an embodiment (Embodiment 1) of the present disclosure. FIGS. 2A and 2B are schematic perspective views of an outer ring constituting the rolling bearing in Embodiment 1. FIGS. 3A and 3B are schematic perspective views of an inner ring constituting the rolling bearing in Embodiment 1. FIG. 4 is a schematic perspective view of the rolling bearing in Embodiment 1, with the outer and inner rings partially removed therefrom. The Z axis direction in FIG. 1 is a direction along a first axis direction in which a central axis R of the rolling bearing extends. The Z axis direction is a thickness direction of the rolling bearing. In contrast, the X-Y plane in FIG. 1 is a plane in a radial direction of the rolling bearing.

Referring to FIGS. 1 to 4, the rolling bearing 1 in Embodiment 1 includes an outer ring 1A, an inner ring 1B, and a plurality of rollers 1C as rolling elements. The outer ring 1A and the inner ring 1B have a common central axis R. The outer ring 1A and the inner ring 1B are made of steel. The inner ring 1B is arranged on an inner circumference side of the outer ring 1A. In Embodiment 1, the outer ring 1A and the inner ring 1B are made of steel plates that have been worked into a predetermined shape. In Embodiment 1, the steel that constitutes the outer ring 1A and the inner ring 1B is, for example, SCM415 as specified in the JIS standard.

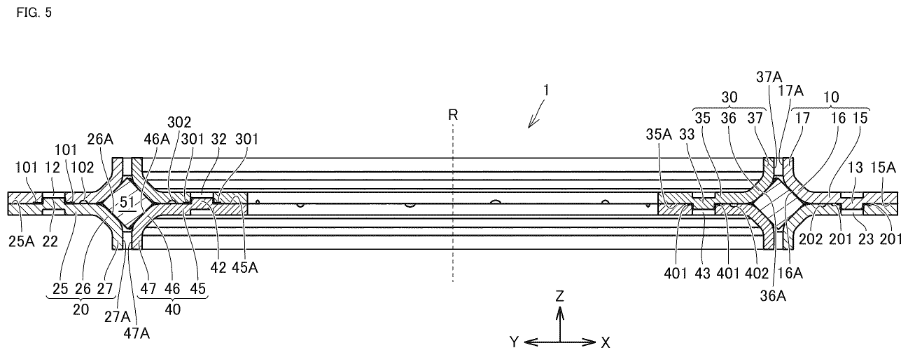

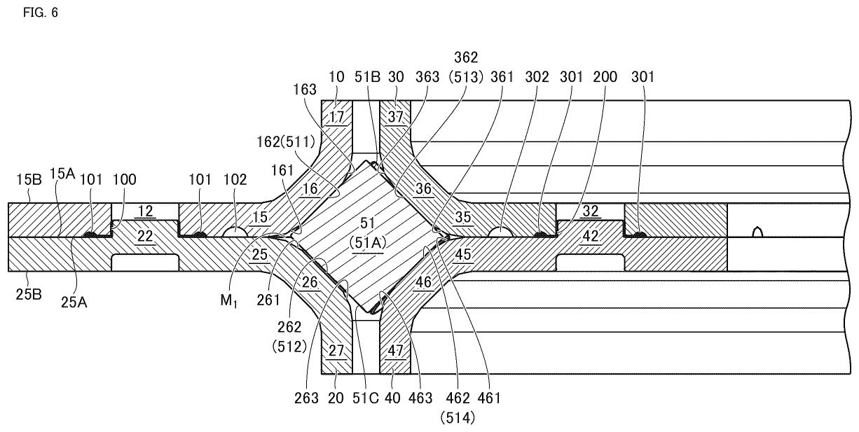

FIG. 5 is a cross-sectional view of the rolling bearing 1 taken along A-A in FIG. 1. FIG. 5 is a cross-sectional view including cross sections of first rollers 51 (FIG. 4). FIG. 6 is an enlarged cross-sectional view of the area around a first roller 51 in FIG. 5.

Referring to FIG. 1, the outer ring 1A includes an annular first outer ring 10 and an annular second outer ring 20. In Embodiment 1, the first outer ring 10 and the second outer ring 20 have the same shape. FIGS. 2A and 2B are perspective views of the first outer ring 10 seen in different angles. Referring to FIGS. 2A, 2B, and 5, the first outer ring 10 includes a first portion 15, a second portion 16, and a third portion 17. In Embodiment 1, the first portion 15, the second portion 16, and the third portion 17 have the same thickness. The first portion 15 has a disk annular shape. The first portion 15 has a common central axis with the central axis R of the rolling bearing 1. The second portion 16 has a tubular shape. The external shape of the second portion 16 is a truncated cone shape. The second portion 16 extends from an inner edge of the first portion 15 such that its inner diameter decreases with increasing distance from the first portion 15 in the Z axis direction. The second portion 16 has an annular inner circumferential surface 16A. The inner circumferential surface 16A has a common central axis with the central axis R of the rolling bearing 1. The third portion 17 has a cylindrical shape. The third portion 17 has a common central axis with the central axis R of the rolling bearing 1. The third portion 17 is connected to an end of the second portion 16 opposite to the first portion 15 in the Z axis direction and extends along the Z axis direction.

Referring to FIGS. 5 and 6, the inner circumferential surface 16A includes an annular first surface 161 as a first region, an annular second surface 162 as a second region, and an annular third surface 163 as a third region. In Embodiment 1, the first surface 161, the second surface 162, and the third surface 163 have a common central axis with the central axis R of the rolling bearing 1. The first surface 161 connects a surface 15A of the first portion 15 on the side in contact with a fourth portion 25 to the second surface 162. In Embodiment 1, in a cross section including the central axis R, the first surface 161 has a curved shape. In the cross section including the central axis R, the second surface 162 has a flat shape. The third surface 163 connects the second surface 162 to an inner circumferential surface 17A of the third portion 17. In Embodiment 1, in the cross section including the central axis R, the third surface 163 has a curved shape.

Referring to FIGS. 2A, 2B, and 4, the first portion 15 has a plurality of (in Embodiment 1, six) mounting holes 11, penetrating in the thickness direction (direction of the central axis R), formed at equal intervals in the circumferential direction. In the first portion 15, either one of a protruding portion 13 and a through hole 12 is formed alternately between adjacent mounting holes 11, aligned in the circumferential direction. It should be noted that the rolling bearing 1 can be fixed to an external member by, for example, inserting bolts to the mounting holes 11 and screwing the bolts into screw holes in the external member.

In Embodiment 1, three protruding portions 13 are formed at equal intervals in the circumferential direction of the first portion 15. The protruding portions 13 are formed on the surface 15A of the first portion 15. The protruding portion 13 is a columnar protruding portion that protrudes from the surface 15A in the thickness direction. The protruding portion 13 is defined by a cylindrical side face 13A rising from the surface 15A and a circular end face 13C defining an end face of the cylinder. While three protruding portions 13 are formed in Embodiment 1, the number of the protruding portions is not limited thereto; it may be two to 16, for example.

In Embodiment 1, three through holes 12 are formed at equal intervals in the circumferential direction of the first portion 15. The through hole 12 is a through hole that penetrates in the thickness direction of the first portion 15 from the surface 15A to a surface 15B of the first portion 15. The through hole 12 is defined by a cylindrical inner circumferential wall 12A that extends to connect the surface 15A and the surface 15B. The through hole 12 has a shape corresponding to the protruding portion 13. That is, the protruding portion 13 and the through hole 12 are equal in diameter. (As used herein, being equal does not mean that the two values are mathematically identical; it includes the case where they have different diameters to the extent that they can be fitted with each other.) While three through holes 12 are formed in Embodiment 1, the number of the through holes is not limited thereto; it may be two to 16, for example. On the surface 15A, a ring-shaped recess 101 is formed around the through hole 12 to surround the through hole 12. On the surface 15A, a groove 102 is formed between the through hole 12 and the second portion 16, the groove surrounding the through hole 12 and having its both ends opening to the outer circumference side of the first outer ring 10. That is, the groove 102 demarcates the through hole 12 from the second portion 16.

Referring to FIGS. 1, 5, and 6, the second outer ring 20 is arranged alongside the first outer ring 10 in the Z axis direction and is fixed to the first outer ring 10. The second outer ring 20 includes a fourth portion 25, a fifth portion 26, and a sixth portion 27. In Embodiment 1, the fourth portion 25, the fifth portion 26, and the sixth portion 27 have the same thickness. In Embodiment 1, the thickness of the first outer ring 10 coincides with the thickness of the second outer ring 20. The fourth portion 25 has a disk annular shape. The surface 15A of the first outer ring 10 is opposite to and in contact with one surface 25A of the fourth portion 25 of the second outer ring 20. The fourth portion 25 has a common central axis with the central axis R of the rolling bearing 1. The fifth portion 26 has a tubular shape. The external shape of the fifth portion 26 is a truncated cone shape. The fifth portion 26 extends from an inner edge of the fourth portion 25 such that its inner diameter decreases with increasing distance from the fourth portion 25 in the Z axis direction. The fifth portion 26 extends to the opposite side of the second portion 16 in the Z axis direction. The fifth portion 26 has an inner circumferential surface 26A of an annular shape. The inner circumferential surface 26A has a common central axis with the central axis R of the rolling bearing 1. The sixth portion 27 has a cylindrical shape. The sixth portion 27 has a common central axis with the central axis R of the rolling bearing 1. The sixth portion 27 is connected to an end of the fifth portion 26 opposite to the fourth portion 25 in the Z axis direction and extends along the Z axis direction to the opposite side of the third portion 17.

The inner circumferential surface 26A includes an annular fourth surface 261, an annular fifth surface 262, and an annular sixth surface 263. The fourth surface 261, the fifth surface 262, and the sixth surface 263 have a common central axis with the central axis R of the rolling bearing 1. The fourth surface 261 connects the surface 25A of the fourth portion 25 to the fifth surface 262. In a cross section including the central axis R, the fourth surface 261 has a curved shape. In the cross section including the central axis R, the fifth surface 262 has a flat shape. The sixth surface 263 connects the fifth surface 262 to an inner circumferential surface 27A of the sixth portion 27. In the cross section including the central axis R, the sixth surface 263 has a curved shape.

Referring to FIG. 4, the fourth portion 25 of the second outer ring 20 has a plurality of (in Embodiment 1, six) mounting holes 21, penetrating in the thickness direction (Z axis direction), formed at equal intervals in the circumferential direction. In the fourth portion 25, either one of a protruding portion 22 and a through hole 23 is formed alternately between adjacent mounting holes 21, aligned in the circumferential direction.

In Embodiment 1, three protruding portions 22 are formed at equal intervals in the circumferential direction of the fourth portion 25. The protruding portion 22 is a columnar protruding portion that protrudes in the thickness direction (Z axis direction) from the surface 25A of the fourth portion 25. The protruding portion 22 is defined by a cylindrical side face 22A rising from the surface 25A and a circular end face 22C defining an end face of the cylinder. While three protruding portions 22 are formed in Embodiment 1, the number of the protruding portions is not limited thereto; it may be two to 16, for example.

In Embodiment 1, the second outer ring 20 has three through holes 23 formed at equal intervals in the circumferential direction of the fourth portion 25. The through hole 23 is a through hole that penetrates in the thickness direction of the fourth portion 25 from the surface 25A to a surface 25B. The through hole 23 is defined by a cylindrical inner circumferential wall 23A that extends to connect the surface 25A and the surface 25B. The through hole 23 has a shape corresponding to the protruding portion 22. That is, the protruding portion 13 and the through hole 12 are equal in diameter. While three through holes 23 are formed in Embodiment 1, the number of the through holes is not limited thereto; it may be two to 16, for example. On the surface 25A, a ring-shaped recess 201 is formed around the through hole 23 to surround the through hole 23. Further, on the surface 25A, a groove 202 is formed between the through hole 23 and the fifth portion 26, the groove surrounding the through hole 23 and having its both ends opening to the outer circumference side of the second outer ring 20. That is, the groove 202 demarcates the through hole 23 from the fifth portion 26.

Referring to FIGS. 5 and 6, the first outer ring 10 and the second outer ring 20 are opposite and fixed to each other at the surface 15A of the first portion 15 in the first outer ring 10 and one surface 25A of the fourth portion 25 in the second outer ring 20. Specifically, the through hole 12 of the first portion 15 and the protruding portion 22 of the fourth portion 25 are fitted together, and the protruding portion 13 of the first portion 15 and the through hole 23 of the fourth portion 25 are fitted together. Further, the fitting portion between the through hole 12 and the protruding portion 22 and the fitting portion between the protruding portion 13 and the through hole 23 are each bonded by an adhesive. Stated specifically, a layer 100 of the adhesive is formed between the inner circumferential walls 12A, 23A of the through holes 12, 23 and the side faces 13A, 22A of the protruding portions 13, 22.

In Embodiment 1, the layer 100 of the adhesive extends around the fitting portions between the protruding portions 13, 22 and the through holes 12, 23, i.e., over the opposing surfaces of the surface 15A and the surface 25A. The layer 100 reaches the grooves 101, 201 surrounding the through holes 12, 23. That is, the grooves 101, 201 are filled with the adhesive (solid resin) constituting the layer 100. While the layer 100 of the adhesive extends over the opposing surfaces of the surface 15A and the surface 25A in Embodiment 1, alternatively, the layer of the adhesive may be present only at the fitting portion between the protruding portion and the through hole, i.e., only between the inner circumferential wall of the through hole and the side face of the protruding portion. In the case where the layer of the adhesive extends from the fitting portion over the opposing surfaces, the bonding is achieved in two directions of axial and plane directions of the rolling bearing, further enhancing the adhesion strength to fix the first and second outer rings.

Referring to FIG. 1, the inner ring 1B includes an annular first inner ring 30 and an annular second inner ring 40. In Embodiment 1, the first inner ring 30 and the second inner ring 40 have the same shape. FIGS. 3A and 3B are perspective views of the first inner ring 30 seen in different angles.

Referring to FIGS. 3A, 3B, 5, and 6, the first inner ring 30 includes a seventh portion 35, an eighth portion 36, and a ninth portion 37. In Embodiment 1, the seventh portion 35, the eighth portion 36, and the ninth portion 37 have the same thickness. In Embodiment 1, the thickness of the first outer ring 10 coincides with the thickness of the first inner ring 30. The seventh portion 35 has a disk annular shape. The seventh portion 35 has a common central axis with the central axis R of the rolling bearing 1. The eighth portion 36 has a tubular shape. The external shape of the eighth portion 36 is a truncated cone shape. The eighth portion 36 extends from an outer edge of the seventh portion 35 such that its outer diameter increases with increasing distance from the seventh portion 35 in the Z axis direction. The eighth portion 36 has an annular outer circumferential surface 36A. The outer circumferential surface 36A has a common central axis with the central axis R of the rolling bearing 1. The ninth portion 37 has a cylindrical shape. The ninth portion 37 has a common central axis with the central axis R of the rolling bearing 1. The ninth portion 37 is connected to an end of the eighth portion 36 opposite to the seventh portion 35 in the Z axis direction and extends along the Z axis direction.

Referring to FIGS. 5 and 6, the outer circumferential surface 36A includes an annular seventh surface 361, an annular eighth surface 362, and an annular ninth surface 363. The seventh surface 361, the eighth surface 362, and the ninth surface 363 have a common central axis with the central axis R of the rolling bearing 1. The seventh surface 361 connects a surface 35A of the seventh portion 35 on the side in contact with a tenth portion 45 to the eighth surface 362. In a cross section including the central axis R, the seventh surface 361 has a curved shape. In the cross section including the central axis R, the eighth surface 362 has a flat shape. The eighth surface 362 opposes the fifth surface 262. In Embodiment 1, in the cross section including the central axis R, the eighth surface 362 and the fifth surface 262 are arranged in parallel. The ninth surface 363 connects the eighth surface 362 to an outer circumferential surface 37A of the ninth portion 37. In the cross section including the central axis R, the ninth surface 363 has a curved shape.

Referring to FIGS. 3A, 3B, and 5, the seventh portion 35 has a plurality of (in the present embodiment, six) mounting holes 31, penetrating in the thickness direction (Z axis direction), formed at equal intervals in the circumferential direction. In the seventh portion 35, between adjacent mounting holes 31 in the circumferential direction, either one of a protruding portion 33 and a through hole 32 is formed alternately, aligned in the circumferential direction.

In Embodiment 1, three protruding portions 33 are formed at equal intervals in the circumferential direction of the seventh portion 35. The protruding portion 33 is a columnar protruding portion that protrudes in the thickness direction from the surface 35A of the seventh portion 35. The protruding portion 33 is defined by a cylindrical side face 33A rising from the surface 35A and a circular end face 33C defining an end face of the cylinder. While three protruding portions 33 are formed in Embodiment 1, the number of the protruding portions is not limited thereto; it may be two to 16, for example.

In Embodiment 1, three through holes 32 are formed at equal intervals in the circumferential direction of the seventh portion 35. The through hole 32 is a through hole that penetrates in the thickness direction from the surface 35A to a surface 35B of the seventh portion 35. The through hole 32 is defined by a cylindrical inner circumferential wall 32A that extends to connect the surface 35A and the surface 35B. The through hole 32 has a shape corresponding to the protruding portion 33. That is, the through hole 32 and the protruding portion 33 are equal in diameter. While three through holes 32 are formed in Embodiment 1, the number of the through holes is not limited thereto; it may be two to 16, for example. On the surface 35A, a ring-shaped recess 301 is formed around the through hole 32 to surround the through hole 32. Further, on the surface 35A, a groove 302 is formed between the through hole 32 and the eighth portion 36, the groove surrounding the through hole 32 and having its both ends opening to the inner circumference side of the first inner ring 30. The groove 302 demarcates the through hole 32 from the eighth portion 36.

Referring to FIGS. 4, 5, and 6, the second inner ring 40 is arranged alongside the first inner ring 30 in the Z axis direction and is fixed to the first inner ring 30. The second inner ring 40 includes a tenth portion 45, an eleventh portion 46, and a twelfth portion 47. In Embodiment 1, the tenth portion 45, the eleventh portion 46, and the twelfth portion 47 have the same thickness. In Embodiment 1, the thickness of the second inner ring 40 coincides with the thickness of the first outer ring 10. The tenth portion 45 has a disk annular shape. The surface 35A of the first inner ring 30 is opposite to and in contact with one surface 45A of the tenth portion of the second inner ring 40. The tenth portion 45 has a common central axis with the central axis R of the rolling bearing 1. The eleventh portion 46 has a tubular shape. The external shape of the eleventh portion 46 is a truncated cone shape. The eleventh portion 46 extends from an outer edge of the tenth portion 45 such that its outer diameter increases with increasing distance from the tenth portion 45 in the Z axis direction. The eleventh portion 46 extends to the opposite side of the eighth portion 36 in the Z axis direction. The eleventh portion 46 has an annular outer circumferential surface 46A. The outer circumferential surface 46A has a common central axis with the central axis R of the rolling bearing 1. The twelfth portion 47 has a cylindrical shape. The twelfth portion 47 has a common central axis with the central axis R of the rolling bearing 1. The twelfth portion 47 is connected to an end of the eleventh portion 46 opposite to the tenth portion 45 in the Z axis direction and extends along the Z axis direction to the opposite side of the ninth portion 37.

The outer circumferential surface 46A includes an annular tenth surface 461, an annular eleventh surface 462, and an annular twelfth surface 463. The tenth surface 461, the eleventh surface 462, and the twelfth surface 463 have a common central axis with the central axis R of the rolling bearing 1. The tenth surface 461 connects the surface 45A of the tenth portion 45 on the side in contact with the seventh portion 35 to the eleventh surface 462. In a cross section including the central axis R, the tenth surface 461 has a curved shape. In the cross section including the central axis R, the eleventh surface 462 has a flat shape. The eleventh surface 462 opposes the second surface 162. In Embodiment 1, in the cross section including the central axis R, the eleventh surface 462 and the second surface 162 are arranged in parallel. In the cross section including the central axis R, a line segment connecting the second surface 162 and the eleventh surface 462 intersects (is orthogonal to) a line segment connecting the fifth surface 262 and the eighth surface 362. The twelfth surface 463 connects the eleventh surface 462 to an outer circumferential surface 47A of the twelfth portion 47. In the cross section including the central axis R, the twelfth surface 463 has a curved shape.

Referring to FIG. 4, the tenth portion 45 has a plurality of (in the present embodiment, six) mounting holes 41, penetrating in the thickness direction (Z axis direction), formed at equal intervals in the circumferential direction. In the tenth portion 45, between adjacent mounting holes 41 in the circumferential direction, either one of a protruding portion 42 and a through hole 43 is formed alternately, aligned in the circumferential direction.

In Embodiment 1, three protruding portions 42 are formed at equal intervals in the circumferential direction of the tenth portion 45. The protruding portion 42 is a columnar protruding portion that protrudes in the thickness direction from the surface 45A of the tenth portion 45. The protruding portion 42 is defined by a cylindrical side face 42A rising from the surface 45A and a circular end face 42C defining an end face of the cylinder. While three protruding portions 42 are formed in Embodiment 1, the number of the protruding portions is not limited thereto; it may be two to 16, for example.

In Embodiment 1, three through holes 43 are formed at equal intervals in the circumferential direction of the tenth portion 45. The through hole 43 is a through hole that penetrates in the thickness direction from the surface 45A to a surface 45B of the tenth portion 45. The through hole 43 is defined by a cylindrical side face 43A that extends to connect the surface 45A and the surface 45B. The through hole 43 has a shape corresponding to the protruding portion 42. That is, the through hole 43 and the protruding portion 42 are equal in diameter. While three through holes 43 are formed in Embodiment 1, the number of the through holes is not limited thereto; it may be two to 16, for example. On the surface 45A, a ring-shaped recess 401 is formed around the through hole 43 to surround the through hole 43. Further, on the surface 45A, a groove 402 is formed between the through hole 43 and the eleventh portion 46, the groove surrounding the through hole 43 and having its both ends opening to the inner circumference side of the second inner ring 40. The groove 402 demarcates the through hole 43 from the eleventh portion 46.

The first inner ring 30 and the second inner ring 40 are opposite and fixed to each other at the surface 35A of the seventh portion 35 in the first inner ring 30 and one surface 45A of the tenth portion 45 in the second inner ring 40. Specifically, the through hole 32 of the seventh portion 35 and the protruding portion 42 of the tenth portion 45 are fitted together, and the protruding portion 33 of the seventh portion 35 and the through hole 43 of the tenth portion 45 are fitted together. Further, the fitting portion between the through hole 32 and the protruding portion 42 and the fitting portion between the protruding portion 33 and the through hole 43 are each bonded by an adhesive. Stated more specifically, a layer 200 of the adhesive is formed between the inner circumferential walls 32A, 43A of the through holes 32, 43 and the side faces 33A, 42A of the protruding portions 33, 42.

In Embodiment 1, the layer 200 of the adhesive extends around the fitting portions between the protruding portions 33, 42 and the through holes 32, 43, i.e., over the opposing surfaces of the surface 35A and the surface 45A. The layer 200 reaches the grooves 301, 401 surrounding the through holes 32, 43. The grooves 301, 401 are filled with the adhesive constituting the layer 200. While the layer 200 of the adhesive extends over the opposing surfaces of the surface 35A and the surface 45A in Embodiment 1, alternatively, the layer of the adhesive may be present only at the fitting portion between the protruding portion and the through hole, i.e., only between the inner circumferential wall of the through hole and the side face of the protruding portion. In the case where the layer of the adhesive extends from the fitting portion over the opposing surfaces, the bonding is achieved in two directions of axial and plane directions of the rolling bearing, further enhancing the adhesion strength to fix the first inner ring 30 and the second inner ring 40.

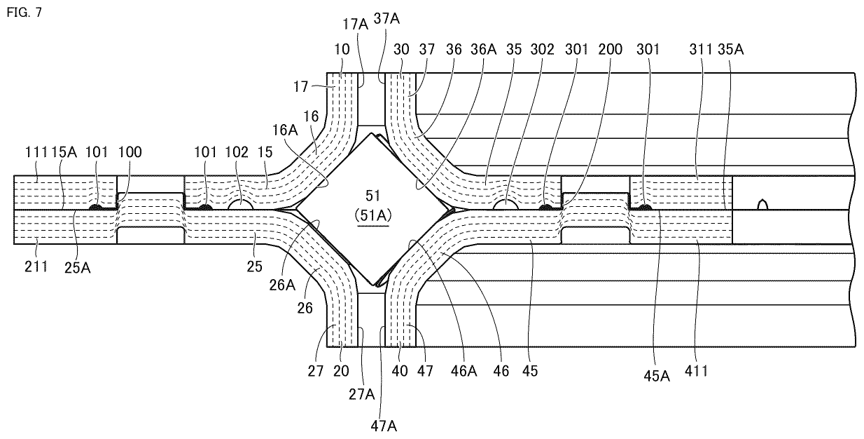

FIG. 7 is a diagram illustrating grain flows in a cross section of the rolling bearing 1 taken along A-A in FIG. 1. Referring to FIGS. 6 and 7, in the first outer ring 10, grain flows 111 in the steel that constitutes the first outer ring 10 extend along the surface 15A of the first portion 15, the inner circumferential surface 16A of the second portion 16, and the inner circumferential surface 17A of the third portion 17. The grain flows 111 extend along the first surface 161, the second surface 162, and the third surface 163 of the inner circumferential surface 16A. In Embodiment 1, the grain flows 111 extend parallel to the second surface 162. Similarly, in the second outer ring 20, grain flows 211 in the steel that constitutes the second outer ring 20 extend along the surface 25A of the fourth portion 25, the inner circumferential surface 26A of the fifth portion 26, and the inner circumferential surface 27A of the sixth portion 27. The grain flows 211 extend along the fourth surface 261, the fifth surface 262, and the sixth surface 263 of the inner circumferential surface 26A. In Embodiment 1, the grain flows 211 extend parallel to the fifth surface 262. Also similarly, in the first inner ring 30, grain flows 311 in the steel that constitutes the first inner ring 30 extend along the surface 35A of the seventh portion 35, the outer circumferential surface 36A of the eighth portion 36, and the outer circumferential surface 37A of the ninth portion 37. The grain flows 311 extend along the seventh surface 361, the eighth surface 362, and the ninth surface 363 of the outer circumferential surface 36A. In Embodiment 1, the grain flows 311 extend parallel to the eighth surface 362. Also similarly, in the second inner ring 40, grain flows 411 in the steel that constitutes the second inner ring 40 extend along the surface 45A of the tenth portion 45, the outer circumferential surface 46A of the eleventh portion 46, and the outer circumferential surface 47A of the twelfth portion 47. The grain flows 411 extend along the tenth surface 461, the eleventh surface 462, and the twelfth surface 463 of the outer circumferential surface 46A. In the present embodiment, the grain flows 411 extend parallel to the eleventh surface 462.

The grain flows 111, 211, 311, and 411 are formed continuously along the third surface 163, the sixth surface 263, the ninth surface 363, and the twelfth surface 463, respectively. Adopting such a configuration can suppress the reduction in rigidity of the first outer ring 10, the second outer ring 20, the first inner ring 30, and the second inner ring 40 when attaching the first outer ring 10, the second outer ring 20, the first inner ring 30, and the second inner ring 40 to another member.

Referring to FIG. 4, the plurality of rollers 1C include a plurality of first rollers 51 and a plurality of second rollers 52. In Embodiment 1, the first rollers 51 and the second rollers 52 are made of steel. In the present embodiment, the first rollers 51 and the second rollers 52 are made of, for example, SUJ2 as specified in the JIS standard. In Embodiment 1, the rollers 1C include 27 first rollers 51 and 27 second rollers 52. The first rollers 51 and the second rollers 52 have a cylindrical shape. Each first roller 51 has a cylindrical outer circumferential surface 51A and circular end faces 51B and 51C at respective ends of the outer circumferential surface 51A. Each second roller 52 has a cylindrical outer circumferential surface 52A and circular end faces 52B and 52C at respective ends of the outer circumferential surface 52A. The first rollers 51 and the second rollers 52 are arranged alternately in the circumferential direction.

Referring to FIG. 6, the first rollers 51 are disposed to be able to roll while contacting, at their outer circumferential surfaces 51A, the second surface 162 in the annular-shaped inner circumferential surface 16A of the second portion 16 of the first outer ring 10. The second surface 162 of the first outer ring 10 constitutes a first rolling surface 511. Further, the first rollers 51 are disposed to be able to roll while contacting the eleventh surface 462 in the annular-shaped outer circumferential surface 46A of the eleventh portion 46 of the second inner ring 40 at their outer circumferential surfaces 51A. The eleventh surface 462 of the second inner ring constitutes a fourth rolling surface 514. The first rolling surface 511 and the fourth rolling surface 514 have a common central axis with the central axis R of the rolling bearing 1. One end face 51B in the axial direction of a first roller 51 is opposite to the eighth surface 362 of the first inner ring 30. The other end face 51C in the axial direction of the first roller 51 is in contact with the fifth surface 262 of the second outer ring. In the present embodiment, an annular space M₁ is formed enclosed by the first surface 161, the fourth surface 261, and the first roller 51.

Further, referring to FIGS. 6 and 7, the steel grain flows 111, 211, 311, and 411 are formed continuously along the first surface 161, the fourth surface 261, the seventh surface 361, and the tenth surface 461. Adopting such a configuration can enhance the flexural strength of the first outer ring 10, the second outer ring 20, the first inner ring 30, and the second inner ring 40 when the first rolling surface 511, a second rolling surface 512, a third rolling surface 513, and the fourth rolling surface 514 are subjected to loads applied from the first rollers 51 and the second rollers 52.

In the rolling bearing 1 in Embodiment 1, in a cross section including the central axis R, the grain flows of the steels constituting the first outer ring 10, the second outer ring 20, the first inner ring 30, and the second inner ring 40 extend along the first rolling surface 511, the second rolling surface 512, the third rolling surface 513, and the fourth rolling surface 514, respectively. That is, the grain flows in each of the first rolling surface 511, the second rolling surface 512, the third rolling surface 513, and the fourth rolling surface 514 are formed continuously without a break. As a result, the contact of the first rollers 51 and the second rollers 52 with the ends of the steel grain flows can be suppressed. This configuration can enhance the durability of the inner ring 1B and the outer ring 1A. As such, the rolling bearing 1 in Embodiment 1 has improved durability.

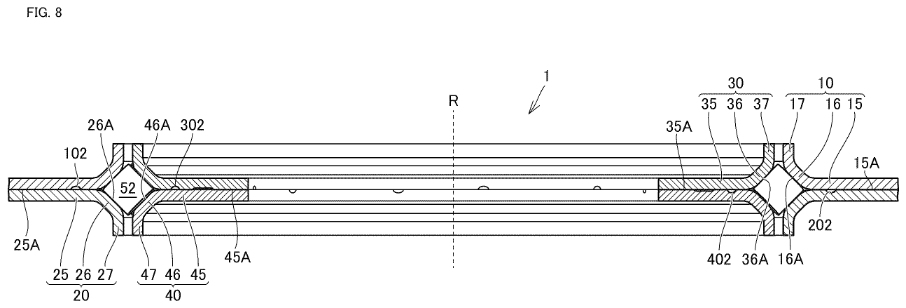

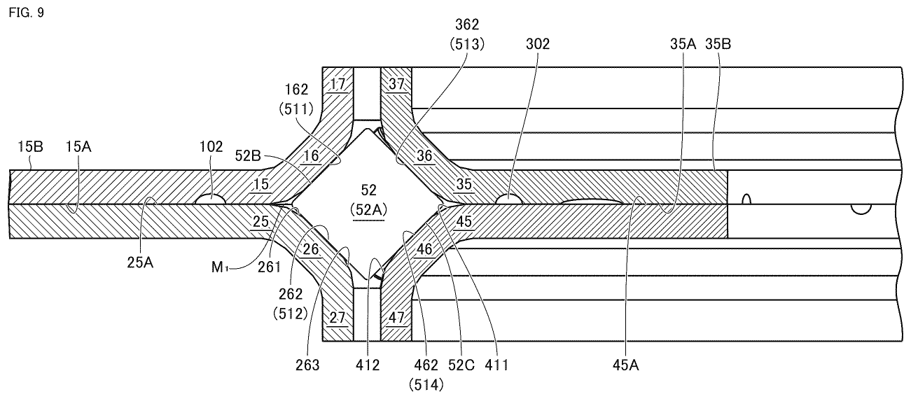

FIG. 8 is a cross-sectional view of the rolling bearing 1 taken along B-B in FIG. 1. FIG. 8 is a cross section including the cross sections of second rollers 52. FIG. 9 is an enlarged cross-sectional view of the area around a second roller in FIG. 8. Referring to FIGS. 8 and 9, the second rollers 52 are disposed to be able to roll while contacting, at their outer circumferential surfaces 52A, the fifth surface 262 of the second outer ring 20 and the eighth surface 362 of the first inner ring 30. The fifth surface 262 of the second outer ring 20 constitutes the second rolling surface 512. The eighth surface 362 of the first inner ring 30 constitutes the third rolling surface 513. The second rolling surface 512 and the third rolling surface 513 have a common central axis with the central axis R of the rolling bearing 1. One end face 52B in the axial direction of a second roller 52 is in contact with the second surface 162 of the first outer ring 10. The other end face 52C in the axial direction of the second roller 52 is opposite to the eleventh surface 462 of the second inner ring 40. In Embodiment 1, the annular space M₁ is formed enclosed by the first surface 161, the fourth surface 261, and the second roller 52 (see FIG. 9). Referring to FIGS. 6 and 9, the first roller 51 has a central axis that intersects (is orthogonal to) a central axis of the second roller 52. Here, the state in which the central axis of the first roller 51 intersects the central axis of the second roller 52 means that when the center of gravity of the first roller 51 and the second roller 52 passes through a predetermined point during rotation of the rolling bearing 1, the central axis of the first roller 51 and the central axis of the second roller 52 intersect (orthogonally) with each other. The first rolling surface 511, the second rolling surface 512, the third rolling surface 513, and the fourth rolling surface 514 define a raceway of the rolling bearing 1 through which the first rollers 51 and the second rollers 52 are able to roll. The grooves 102, 202, 302, and 402 are formed between the raceway and the fitting portions.

A description will now be made of a method for producing the rolling bearing 1 in Embodiment 1. First, a first steel plate, a second steel plate, a third steel plate, and a fourth steel plate having a flat plate shape are prepared. Next, the first steel plate, the second steel plate, the third steel plate, and the fourth steel plate are each subjected to press working. In this manner, the first outer ring 10, the second outer ring 20, the first inner ring 30, and the second inner ring 40 having the shapes shown in FIGS. 2A, 2B, and 3A, 3B are formed.

Next, referring to FIG. 5, the inner circumferential surface 16A of the second portion 16, the inner circumferential surface 26A of the fifth portion 26, the inner circumferential surface 36A of the eighth portion 36, and the inner circumferential surface 46A of the eleventh portion 46 are subjected to known heat treatment. More specifically, carburizing or carbonitriding treatment, and quenching and tempering and the like are performed. Performing the heat treatment can improve the hardness of the inner circumferential surfaces 16A, 26A, 36A, and 46A. In Embodiment 1, no grinding work is performed on the inner circumferential surfaces 16A, 26A, 36A, and 46A. Next, the second inner ring 40 is attached to the first inner ring 30 to form the inner ring 1B. More specifically, an adhesive is applied around the protruding portions 33, 42 and the through holes 43, 43, and then the protruding portions 33 are fitted into the through holes 43 and the protruding portions 42 are fitted into the through holes 32. The inner ring 1B thus formed and the second outer ring 20 are attached to a jig. At this time, they are attached such that the outer circumferential surface 47A of the twelfth portion 47 and the inner circumferential surface 27A of the sixth portion 27 oppose each other (see FIG. 5). Next, the first rollers 51 and the second rollers 52 are disposed alternately in the space enclosed by the inner ring 1B and the second outer ring 20. Next, the first outer ring 10 is attached to the second outer ring 20 to form the outer ring 1A. More specifically, after an adhesive is applied around the protruding portions 13, 22 and the through holes 23, 23, the protruding portions 13 are fitted into the through holes 23 and the protruding portions 22 are fitted into the through holes 12.

For the adhesive for bonding the first outer ring 10 with the second outer ring 20 and the first inner ring 30 with the second inner ring 40, a known adhesive can be used. Examples of the adhesive available include, but are not limited to, anaerobic adhesives, and epoxy adhesive and other resin-based adhesives.

### (Variation 1)

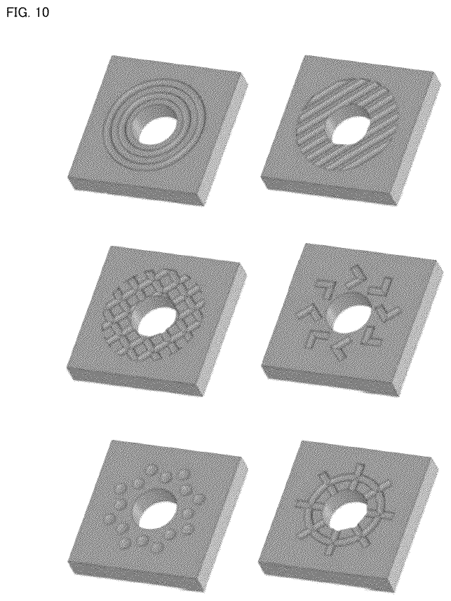

A description will now be made of a variation of the rolling bearing 1 in Embodiment 1. While annular recesses 101, 201, 301, and 401 have been formed around the through holes 12, 23, 32, and 43 to surround the through holes in Embodiment 1, the shape of the recesses is not limited thereto. FIG. 10 shows other examples of the shape of the recesses formed around the through holes. As shown in FIG. 10, the shape of the recess may be multiple rings, or a plurality of linear grooves extending in one direction parallel to each other. The shape of the recess may be a lattice-shaped groove in which a plurality of linear grooves intersect each other, or wedge-shaped grooves may be arranged aligned in the circumferential direction around the through hole. The recess may be in the form of a plurality of dot-shaped recesses dispersedly arranged, or a combination of an annular groove and radially extending linear grooves. Further, the surface around the through hole may be roughened. By providing a recess or roughened surface around the through hole, the bonding area can be increased, and the adhesion strength can be further improved. In addition, the recess or roughened surface can hold the adhesive and prevent the adhesive from spreading to unintended portions.

### (Variation 2)

While the recesses and grooves are formed around the through holes in Embodiment 1, the recesses and grooves may be formed around the protruding portions instead of around the through holes. The recesses and grooves can be formed around the protruding portions in addition to around the through holes. The periphery of a protruding portion is more rigid than the periphery of a through hole. Therefore, there is less risk of loss of rigidity by forming the recesses and grooves. For this reason, there are cases where the recesses and grooves are preferably formed around the protruding portions.

### (Variation 3)

While the case of adopting the first and second rollers 51 and 52 made of steel as the rolling elements has been described in Embodiment 1, not limited to this, first and second rollers 51 and 52 made of ceramic (e.g., alumina or silicon nitride) or resin may also be adopted. Adopting such rollers as described above achieves a weight reduction of the rolling bearing 1. Further, while the first and second rollers 51 and 52 are arranged adjacent to each other in Embodiment 1, a separator can be disposed between the first and second rollers.

### Embodiment 2

A description will now be made of Embodiment 2 of the rolling bearing according to the present disclosure. The rolling bearing 1 in Embodiment 2 basically has a similar structure and exerts similar effects as the rolling bearing in Embodiment 1. However, Embodiment 2 differs from Embodiment 1 in that the outer ring 1A and the inner ring 1B are formed flat, that the rolling elements are balls, and that slits and pin holes are formed. The points that are different from the case of Embodiment 1 will mainly be described below.

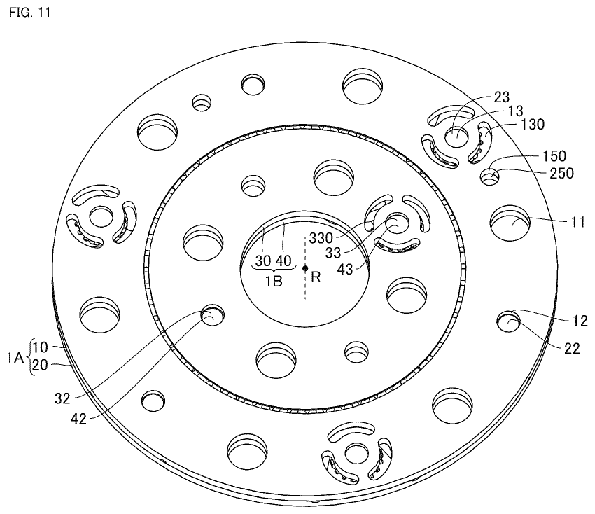

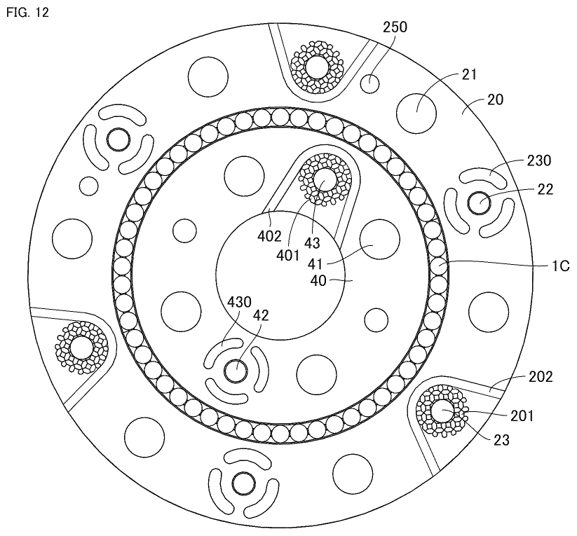

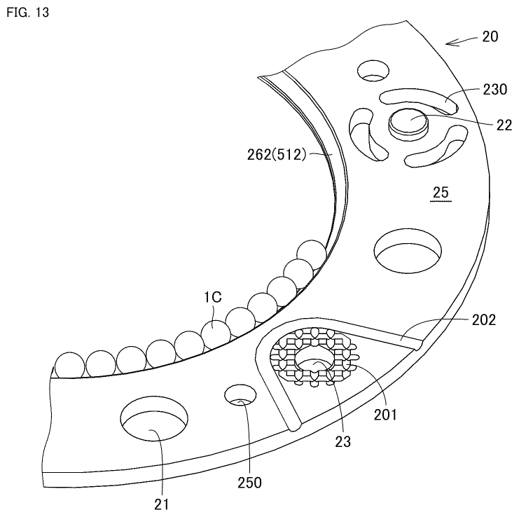

FIG. 11 is a perspective view of a rolling bearing 1 in Embodiment 2. FIG. 12 is a perspective view of the rolling bearing 1 in Embodiment 2, with the first outer ring 10 and the first inner ring 30 removed therefrom. FIG. 13 is an enlarged perspective view of a portion of the second outer ring 20 and rolling elements 1C in Embodiment 2, with the rolling elements 1C partially removed therefrom.

Referring to FIG. 11, the outer ring 1A in Embodiment 2 is formed flat, with no portions protruding in the central axis R direction. The through holes 12 of the first outer ring 10 and the protruding portions 22 of the second outer ring 20 are fitted together, and the protruding portions 13 of the first outer ring 10 and the through holes 23 of the second outer ring 20 are fitted together. These fitting portions are bonded. Further, around the protruding portions 13, slits 130 are formed penetrating in the thickness direction of the first outer ring 10. The slit 130 is an arcuate slit along a portion of the arc of an imaginary circle concentric with the protruding portion 13. Three slits 130 are arranged around a protruding portion 13.

The inner ring 1B in Embodiment 2 is formed flat, with no portions protruding in the central axis R direction. The through holes 32 of the first inner ring 30 and the protruding portions 42 of the second inner ring 40 are fitted together, and the protruding portions 33 of the first inner ring 30 and the through holes 43 of the second inner ring 40 are fitted together. These fitting portions are bonded. Further, around the protruding portions 33, slits 330 are formed penetrating in the thickness direction of the first inner ring 30. The slit 330 is an arcuate slit along a portion of the arc of an imaginary circle concentric with the protruding portion 33. Three slits 330 are arranged around a protruding portion 33.

Referring to FIGS. 11 and 12, the second outer ring 20 and the first outer ring 10 have the same shape, and the second inner ring 40 and the first inner ring 30 have the same shape, so common descriptions are not repeated. In the second outer ring 20, a lattice-shaped recess 201 is formed around a through hole 23. Further, a groove 202 is formed adjacent to the recess 201. Similarly, in the second inner ring 40, a lattice-shaped recess 401 is formed around a through hole 43. The adhesive penetrates into the lattice-shaped recesses 201 and 401 to increase the bonding area, ensuring secure bonding between the outer rings and between the inner rings. Further, a groove 402 is formed adjacent to the recess 401. By having the recesses 201, 401 and the grooves 202, 402 respectively adjacent to each other, even when an excessive amount of adhesive is applied, the adhesive can be discharged to the outside of the rolling bearing without penetrating to the rolling surfaces.

In Embodiment 2, with the provision of the slits 130, 230, 330, and 430, even when there is a slight misalignment between a protruding portion and a through hole to be fitted to each other, the slits can absorb deformation of the inner and outer rings caused by such misalignment. Specifically, if a protruding portion and a through hole are fitted together despite a misalignment therebetween, distortion may occur in the inner ring or outer ring. In such a case, the presence of slits causes deformation to occur in the slit portion, which is less rigid than the surrounding area. Deformation of the slit portion prevents deformation of the portions other than the slits, especially of the rolling surfaces.

In Embodiment 2, in addition to the mounting holes 11, 21, 31, and 41, small through holes 150 and 250 are formed penetrating in the thickness direction. The small through holes 150 and 250 can receive pins (not shown) for use in positioning when attaching the rolling bearing 1 to a counter member. Since the outer ring 1A and the inner ring 1B of Embodiment 2 are flat, protruding portions of the outer ring 1A and the inner ring 1B cannot be used as a reference for positioning. Therefore, the small through holes 150 and 250 are provided, and the positioning pins are inserted into the small through holes 150 and 250, whereby positioning can be done. According to such a configuration, a rolling bearing 1 which is thinner in thickness with the absence of protruding portions and capable of secure positioning is obtained.

### (Variation 4)

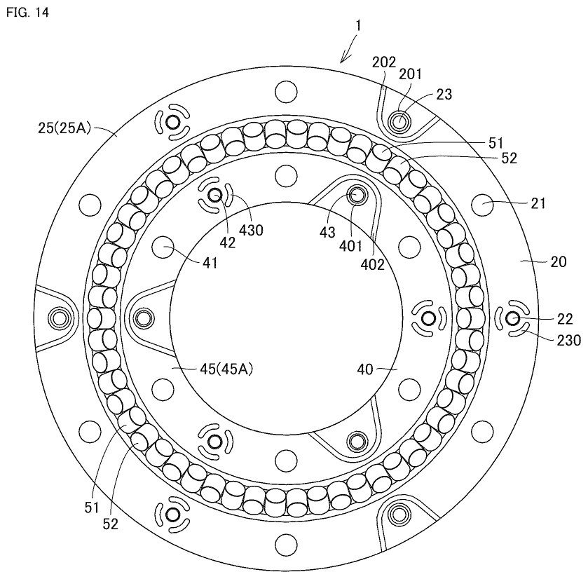

FIG. 14 shows a variation of the rolling bearing 1 according to Embodiment 1. FIG. 14 shows the rolling bearing 1 with the first outer ring and the first inner ring removed therefrom. Slits 230 are provided around the protruding portions 22 in the second outer ring 20. Similarly, slits 430 are provided around the protruding portions 42 in the second inner ring 40. According to the variation of FIG. 14, the first and second outer rings, as well as the first and second inner rings, are securely fixed even if the rolling bearing is thin. Further, even if there is a misalignment between a protruding portion and a through hole, the entire inner and outer rings are not affected, and a rolling bearing having rolling surfaces with high accuracy in roundness and the like is obtained.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1: rolling bearing; 1A: outer ring; 1B: inner ring; 1C: roller; 10: first outer ring; 11, 21, 31, 41: mounting hole; 12, 23, 32, 43, 54A: through hole; 13, 22, 33, 42: protruding portion; 15: first portion; 15A, 18A, 25A, 28A, 35A, 38A, 45A, 48A: surface; 16: second portion; 16A, 17A, 26A, 27A, 36A, 36B, 37B, 46A, 46B, 47B: inner circumferential surface; 16B, 17B, 26B, 27B, 36A, 37A, 46A, 47A, 51A, 51B, 52A, 52B, 55A: outer circumferential surface; 17: third portion; 17C, 27B, 37C, 47B, 51B, 51C, 52B, 52C: end face; 20: second outer ring; 25: fourth portion; 26: fifth portion; 27: sixth portion; 30: first inner ring; 35: seventh portion; 36: eighth portion; 37: ninth portion; 40: second inner ring; 45: tenth portion; 46: eleventh portion; 47: twelfth portion; 51: first roller; 52: second roller; 100, 200: layer; 101, 201, 301, 401: recess; 102, 202, 302, 402: groove, 130, 230, 330, 430: slit; 111, 211, 311, 411: grain flow; 150, 250: small through hole; 161: first surface; 162: second surface; 163: third surface; 261: fourth surface; 262: fifth surface; 263: sixth surface; 361: seventh surface; 362: eighth surface; 363: ninth surface; 461: tenth surface; 462: eleventh surface; 463: twelfth surface; 511: first rolling surface; 512: second rolling surface; 513: third rolling surface; and 514: fourth rolling surface.

1. A rolling bearing comprising:
an outer ring made of steel;
an inner ring made of steel, having a common central axis with the outer ring and arranged on an inner circumference side of the outer ring; and
a plurality of rolling elements disposed to be able to roll on an inner circumferential surface of the outer ring and an outer circumferential surface of the inner ring;
the outer ring including
a first outer ring and a second outer ring arranged alongside the first outer ring in a first axis direction in which the central axis extends, the second outer ring being fixed to the first outer ring,
the inner ring including
a first inner ring and a second inner ring arranged alongside the first inner ring in the first axis direction, the second inner ring being fixed to the first inner ring,
one and the other of opposing portions in the first and second outer rings and in the first and second inner rings having a protruding portion and a through hole corresponding to the protruding portion formed respectively therein, the protruding portion and the through hole being fitted together, the protruding portion and the through hole being bonded to each other.

2. The rolling bearing according to claim 1, wherein the first outer ring, the second outer ring, the first inner ring, and the second inner ring each have both of the protruding portion and the through hole.

3. The rolling bearing according to claim 1, wherein further, opposing surfaces of the first and second outer rings and opposing surfaces of the first and second inner rings are bonded around a fitting portion made up of the protruding portion and the through hole fitted together.

4. The rolling bearing according to claim 3, wherein in the opposing surfaces, a portion around the through hole is roughened, or a recess is formed around the through hole.

5. The rolling bearing according to claim 1, wherein
the first outer ring has an annular first rolling surface constituting the inner circumferential surface of the outer ring,
the second outer ring has an annular second rolling surface constituting the inner circumferential surface of the outer ring,
the first inner ring has an annular third rolling surface constituting the outer circumferential surface of the inner ring and opposing the second rolling surface,
the second inner ring has an annular fourth rolling surface constituting the outer circumferential surface of the inner ring and opposing the first rolling surface, a line segment connecting the fourth rolling surface and the first rolling surface intersecting a line segment connecting the second rolling surface and the third rolling surface in a cross section including a central axis of the first rolling surface,
the first rolling surface, the second rolling surface, the third rolling surface, and the fourth rolling surface define an annular raceway through which the rolling elements are able to roll, and
opposing surfaces of the first and second outer rings and opposing surfaces of the first and second inner rings each have a groove formed therein between the raceway and the fitting portion.

6. The rolling bearing according to claim 5, wherein the groove in the opposing surfaces of the first and second outer rings has both ends opening toward an outer circumference of the outer ring.

7. The rolling bearing according to claim 5, wherein the groove in the opposing surfaces of the first and second inner rings has both ends opening toward an inner circumference of the inner ring.

8. The rolling bearing according to claim 5, wherein in a cross section including the central axis, grain flows in the steel constituting the first outer ring extend along the first rolling surface, grain flows in the steel constituting the second outer ring extend along the second rolling surface, grain flows in the steel constituting the first inner ring extend along the third rolling surface, and grain flows in the steel constituting the second inner ring extend along the fourth rolling surface.
